(19) United States
(12) Patent Application Publication
(10) Pub. No.: US 2021/0309447 A1
(43) Pub. Date: Oct. 7, 2021

(54) Capsule and Method for Making Coffee

(71) Applicant: Leon GIOCHAIS, Athens (GR)

(72) Inventor: Leon GIOCHAIS, Athens (GR)

(21) Appl. No.: 17/283,370

(22) PCT Filed: Mar. 9, 2020
(86) PCT No.: PCT/EP2020/056221

§ 371 Date: Apr. 7, 2021

Related U.S. Application Data
(60) Provisional application No. 62/833,573, filed on Apr. 12, 2019.

(51) Int. Cl. B65D 85/804; A47J 31/06; A47J 31/36; A23F 5/26; A47J 31/46; B65D 81/32

(52) U.S. Cl. CPC B65D 85/8043; A47J 31/0673; B65D 81/3216; A23F 5/26; A47J 31/461; A47J 31/3628

(57) ABSTRACT

The invention relates to a capsule comprising an water capsule configured to contain water, a coffee capsule configured to contain coffee, and a water hole valve disposed on the water capsule, whereby the water capsule holds a quantity of water, the coffee capsule housed within the water capsule holds a quantity of coffee, and the water hole valve disposed on the water capsule is configured to release the water within the water capsule into a coffee machine. The invention further relates to a respective method for making coffee.

### TECHNICAL FIELD

The invention relates to a capsule comprising a coffee capsule configured to contain coffee, whereby the coffee capsule holds a quantity of coffee. The invention further relates to a method for making coffee.

### BACKGROUND ART

Many options are known from prior art for making coffee. Coffee machines are very common but suffer from some issues. For example, water in coffee machines is usually old, and it's difficult to know the last time the water has been refilled. Thus, water could remain in the machine for days or even longer and then used for making coffee. Additionally, there are places and countries where the water has to be bottled, making it tough to obtain water easily for making coffee. It is also difficult in meeting rooms or locations where access to water is in a different room.

### SUMMARY OF INVENTION

It is therefore an object of the invention to provide an improved solution for overcoming said disadvantages.

The object of the invention is solved by the features of the independent claims. Preferred embodiments are detailed in the dependent claims.

Thus, the object is solved by a capsule comprising an water capsule configured to contain water, a coffee capsule configured to contain coffee, and a water hole disposed on the water capsule, whereby the water capsule holds a quantity of water, the coffee capsule housed within the water capsule holds a quantity of coffee, and the water hole disposed on the water capsule is configured to release the water within the water capsule into a coffee machine.

A key point of the invention is therefore that the capsule comprises both water and coffee in a preferably sufficient amount to product a cup or a number of cups of coffees. Thus, the proposed solution resolves current water issues by including water such as for example in the same capsule as the coffee. There is no need to add water into the coffee machine because every coffee capsule contains preferably the necessary quantity of water needed to produce coffee as well as the respective coffee, while coffee and water are separated by said water and coffee capsules. The proposed solution does also not require any water pipe to the coffee machine, as often required for prior art coffee machine, nor any water tank to be regularly refilled. Prior art problems such as old water in coffee machines and taking care of regular water refilling are resolved by the proposed solution. The proposed capsule does therefore allows much more convenient coffee making.

The coffee capsule preferably comprises milled coffee powder and/or the water capsule comprises clean, drinkable water. The quantity of water preferably equals the quantity of water required for one, two, three or a plurality of cups of coffee. The coffee capsule is preferably completely housed within the water capsule. Preferably, the coffee capsule is housed within the water capsule such that at least one preferably two sides of the coffee capsule can be accessed from outside the capsule for respective perforation as describe below.

According to a preferred implementation the capsule comprises a plurality of guides disposed on the water capsule and configured to help keeping the water capsule centered while entering the machine and/or whereby the guides are embossed on the water capsule. Preferably the water capsule comprises two guides arranged distant and parallel to each on a longitudinal side of the water capsule and/or extending in longitudinal direction. The guides advantageously allow guiding the capsule for inserting into the coffee machine.

In another preferred implementation the capsule comprises a plurality of holders disposed on the coffee capsule and configured to keep the inner coffee capsule steady and ready for perforation by the coffee machine. The holders are preferably arranged adjacent to an inner ring described below. Preferably the holders are arranged in regular distances to each other.

According to a further preferred implementation the capsule comprises an air pressure hole disposed on the water capsule and configured to release air pressure once the coffee capsule is perforated during entrance of the water capsule into the machine. The air pressure hole is preferably arranged distant while on the same side of the water capsule than the water hole.

According to a further preferred implementation the coffee capsule comprises a metallic conic UFO shaped container that tapers at one end and/or the water capsule comprises a rectangular shape. Conic UFO shaped container preferably means a form of a truncated cone, whereby top surfaces are preferably parallel aligned with surfaces of longitudinal sides of the rectangular shaped water capsule. Such way it may be possible to use metallic conic UFO shaped coffee capsules known from prior art for respectively within the capsule. Coffee capsule and/or water capsule may also comprise any other suitable form, while using a metallic conic UFO shaped coffee capsule and rectangular shaped water capsule allow of an easy and cost-efficient implementation of the proposed capsule.

In another preferred implementation the coffee capsule is disposed on a side of an inside of the water capsule. Preferably at least one preferably both top surfaces of the conic UFO shaped container are disposed on the inside of the water capsule, preferably are provided as surface of the water capsule.

In another preferred implementation the coffee capsule comprises an inner ring configured for keeping the coffee capsule from exiting the water capsule from its front side. The inner ring preferably surround the side of the coffee capsule opposite to the tapered side and/or is arranged parallel to the longitudinal side of the water capsule.

According to a further preferred implementation the capsule is made of PET and/or PP plastic material constructed via injection moulding. Alternatively, the capsule can made of aluminium. Further alternatively the water capsule is made of PET and/or PP plastic and the coffee capsule is made of aluminium. Polyethylene terephthalate, abbreviated as PET, PETE, PETP or PET-P, is a thermoplastic polymer resin of the polyester family and can be used in combination with glass fibre for engineering resins. Polypropylene, abbreviated as PP, is a thermoplastic polymer and belongs to the group of polyolefins and is partially crystalline and non-polar. PP's properties are similar to polyethylene but slightly harder and more heat resistant. Besides other materials can be used as well. The capsule, the water capsule and/or the coffee capsule are preferably provided liquid-tight and/or pressure-tight. Such way the water and/or the coffee can be stored for some time without becoming decayed.

In another preferred implementation the water capsule comprises between 25 to 100 ml or 50 ml of water and/or the coffee capsule comprises between 5 to 20 grams, in particular 7 to 12 grams of coffee in powder form. In a further preferred embodiment the water capsule comprises 10 to 200, 300 or 500 ml water and/or 5 to 100 grams coffee. Such way the same capsule may be used to produce a plurality of coffee cups in parallel and/or one after another.

The object is further solved by the coffee machine comprising the capsule as described before. Such coffee machine does not require a water tank as known from prior art as all water required for making coffee is already contained in the capsule.

The object is even further solved by a method for making coffee comprising the steps of
inserting a capsule containing a water capsule and a coffee capsule into a coffee machine,
penetrating a back side of the coffee capsule via a first perforator configured to form a coffee hole in the back of the coffee capsule,
penetrating a water hole disposed on a back side of the water capsule via a tube disposed at an end of a sliding path so that water is released from the water capsule into a heater tank within the coffee machine,
heating the water via the heater tank,
injecting water from the heater tank into the coffee capsule through the coffee hole, and
forming coffee once the water mixes with the coffee in the coffee capsule.

The capsule can be manually or automatically inserted into the coffee machine. The penetrating may occur by manually pressing the capsule into the coffee machine and/or by means of an automatic penetration by the first perforator. The first perforator can be provided as a tip that is inserted into the coffee capsule thereby forming the coffee hole. The water is preferably released via the tube into the heater tank. Penetrating the coffee capsule and the water capsule occurs preferably at the same time by respectively inserting the capsule. The sliding path and/or the tube is preferably orientated parallel to the back side and/or to the guides. For heating the water the coffee machine may comprise a respective heating means. The heated water that is injected in to the coffee capsule preferably comprises a temperature between 92 to 96° C. For injecting the water the coffee machine may comprise a pump or a similar means. The heated water is preferably pushed through the coffee capsule, for example leaving at an output hole arranged at an opposite side of the coffee hole into a cup.

In a preferred implementation the method comprises the step of:
penetrating the back side of the coffee capsule in three spots via the first perforator configured to form three symmetric coffee holes in the back side of the coffee capsule,
penetrating an aluminium covered water hole disposed on the back side of the water capsule via a metallic sharp tube disposed at the end of the sliding path, and/or
injecting water from the heater tank into the coffee capsule through the coffee holes into a silicon tube, and
filling of a cup with the coffee from the silicon tube for between 10 to 20 seconds, in particular 13 to 15 seconds.

Such way the silicon tube preferably comprises the coffee ready for drinking, to be released into the cup. The silicon tube may comprise a volume of 100 ml or more. The capsule, the coffee machine and/or the method can be used for making regular coffee, expresso, milk coffee, cappuccino and any other coffee flavours known from prior art.

In another preferred implementation the method comprises the step of sliding down the water capsule the sliding path at the same time as the coffee capsule is being penetrated via the first perforator. Therefore the metallic sharp tube that penetrates the water capsule is preferably disposed at the end of the sliding path. Preferably the coffee capsule and the water capsule are mechanically attached to each other for allowing the joint sliding.

In a further preferred implementation the method comprises the step of flowing the water at a pressure of 20 bar through the coffee capsule and into a cup for producing the coffee. Alternatively, the pressure may be in the range of 5 to 25 bar, preferably 10 to 20 bar, more preferably 15 bar.

In another preferred implementation the capsule comprises an air pressure hole disposed on the water capsule and configured to release air pressure once the coffee capsule is perforated during entrance of the water capsule into the machine. As air pressure is released, water can exit into the coffee machine.

In a further preferred implementation the coffee capsule comprises a metallic conic UFO shaped container that tapers at one end and/or the water capsule comprises a rectangular shape. Conic UFO shaped container preferably means a form of a truncated cone, whereby top surfaces are preferably parallel aligned with surfaces of longitudinal sides of the rectangular shaped water capsule. Such way it may be possible to use metallic conic UFO shaped coffee capsules known from prior art for respectively within the capsule. Coffee capsule and/or water capsule may also comprise any other suitable form, while using a metallic conic UFO shaped coffee capsule and rectangular shaped water capsule allow of an easy and cost-efficient implementation of the proposed capsule.

Further embodiments and advantages of the method are directly and unambiguously derived by the person skilled in the art from the capsule as described before.

### BRIEF DESCRIPTION OF DRAWINGS

These and other aspects of the invention will be apparent from and elucidated with reference to the embodiment described hereinafter.

In the drawings:

FIG. 1a shows a capsule according to an exemplary embodiment in a perspective view,

FIG. 1b shows the capsule according to the exemplary embodiment of FIG. 1a in a side view,

FIG. 2 shows the capsule according to the exemplary embodiment of FIGS. 1a and 1b operating within a coffee machine in a perspective view, and

FIG. 3 shows the capsule according to the exemplary embodiment of FIG. 2 operating within the coffee machine in a side view.

### DESCRIPTION OF EMBODIMENTS

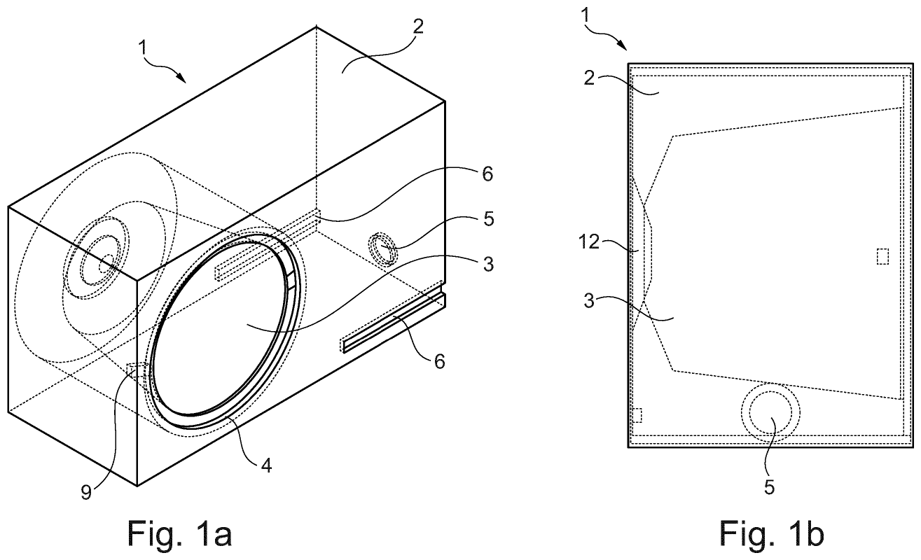

FIGS. 1a and 1b show a capsule 1 according to an exemplary embodiment in a perspective view and in a side view, respectively. The capsule 1 is made of PET plastic material and such wise constructed via injection moulding. The capsule 1 comprises an outer capsule 2 and a an inner capsule 3, both provided as closed, liquid-tight capsules. The outer capsule 2 comprises a rectangular shape and the inner capsule 3 comprises a metallic conic UFO shaped container that tapers at one end.

The inner capsule 3 is housed within the outer capsule 2 such that, as can be seen from FIG. 1b, the tapered side and the opposite side thereto align at least partly parallel with longitudinal, opposite sides of the rectangular shaped outer capsule 2. The inner capsule 3 is thus completely housed respectively embedded within the outer capsule 3. For keeping the inner capsule 3 from exiting the water outer capsule 2 an inner ring 4 is provided which is attached to the outer capsule 2 and keeps the inner capsule 3 at the opposite side to the tapered side parallel to the longitudinal front side of the outer capsule 2.

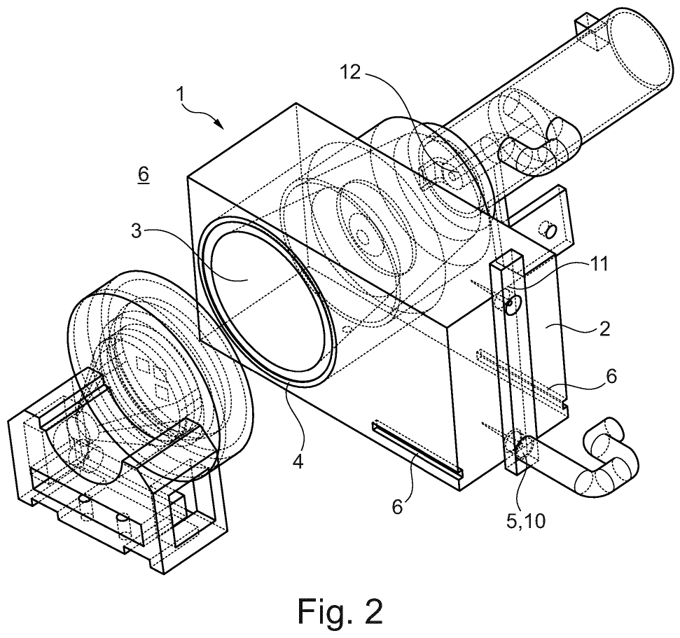

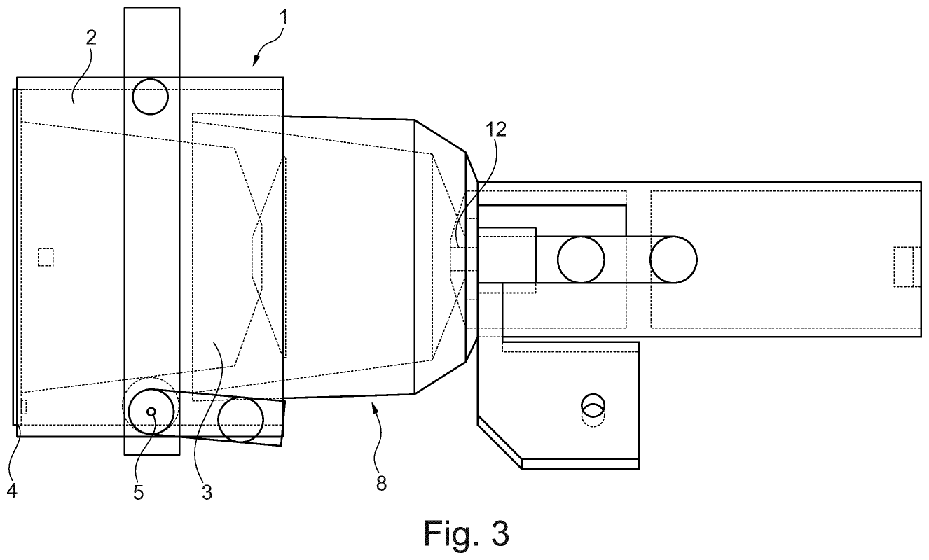

The inner capsule 3 is filled with approximately 7 to 12 grams of coffee in powder form, and is thus also referred to as coffee capsule 3. The outer capsule 2 is filled with the inner capsule 3 and comprises approximately 50 ml of water as quantity of water, and is thus also referred to as water capsule 2. The water capsule 2 further comprises a water hole 5 disposed on a lateral side the water capsule 2, which is configured to release the water within the water capsule 2 into a coffee machine 6, only schematically depicted in FIGS. 2 and 3 showing the capsule 1 operating within the coffee machine in a perspective view and side view.

For making coffee, the capsule 1 is first inserted into an upper portion of the coffee machine 6 via a sliding path. The capsule therefore comprises a plurality of guides 7 disposed on longitudinal sides of respectively embossed on the water capsule 2 i.e. two parallel guides 7 extending in longitudinal direction, which help keeping the outer capsule 2 respectively the capsule 1 centered while entering the coffee machine 6 along the sliding path. Next, the tapered back side of the coffee capsule 3 is penetrated in three spots via a first perforator 8, thereby forming three symmetric coffee holes 12 in the tapered back side of the coffee capsule 3. For keeping the inner coffee capsule 3 steady and ready for perforation, a plurality of holders 9 are disposed on the coffee capsule 3 adjacent to and around the inner ring 4.

In a next step, the aluminium covered water hole 5 disposed on the lateral back side of the water capsule 2 is penetrated via a metallic sharp tube 10 disposed at an end of the sliding path. Next, water is released from the water capsule 2 and into a heater tank, not shown, within the coffee machine 6. Parallel to penetrating the water hole 5, an air pressure hole 11 disposed on the water capsule 3 is penetrated. Next, the water is heated within the heater tank and/or by other heating means. Thereafter the heated water is injected from the heater tank into the coffee capsule 3 through the three coffee holes 12 and into a silicon tube with a pressure of 20 bar, forming coffee once the heated water mixes with the coffee in the coffee capsule 3. The process terminates with the filling of a cup, not shown, with the coffee from the silicon tube for approximately 13 to 15 seconds.

While the invention has been illustrated and described in detail in the drawings and foregoing description, such illustration and description are to be considered illustrative or exemplary and not restrictive; the invention is not limited to the disclosed embodiments. Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

### REFERENCE SIGNS LIST

1 capsule
2 outer capsule, water capsule
3 inner capsule, coffee capsule
4 inner ring
5 water hole
6 coffee machine
7 guide
8 perforator
9 holder
10 tube
11 air pressure hole
12 coffee hole

1. A capsule comprising
a water capsule configured to contain water,
a coffee capsule configured to contain coffee, and
a water hole valve disposed on the water capsule, whereby
the water capsule holds a quantity of water,
the coffee capsule housed within the water capsule holds a quantity of coffee, and
the water hole disposed on the water capsule is configured to release the water within the water capsule into a coffee machine.

2. The capsule according to claim 1, comprising a plurality of guides disposed on the water capsule and configured to help keeping the water capsule centered while entering the coffee machine.

3. The capsule according to claim 1, comprising a plurality of holders disposed on the coffee capsule and configured to keep the inner coffee capsule steady and ready for perforation by the coffee machine.

4. The capsule according to claim 1, comprising an air pressure hole disposed on the water capsule and configured to release air pressure once the coffee capsule is perforated during entrance of the water capsule into the coffee machine.

5. The capsule according to claim 1, whereby the coffee capsule is disposed on a side of an inside of the water capsule.

6. The capsule according to claim 1, whereby the coffee capsule comprises a metallic conic UFO shaped container that tapers at one end.

7. The capsule according to claim 1, whereby the coffee capsule comprises an inner ring configured for keeping the coffee capsule from exiting the water capsule from its front side.

8. The capsule according to claim 1, whereby the capsule is made of at least one of PET or PP plastic material constructed via injection moulding.

9. The capsule according to claim 1, whereby the water capsule comprises between 25 to 100 ml or 50 ml of water.

10. A coffee machine comprising a capsule according to claim 1.

11. A method for making coffee comprising the steps of
inserting a capsule containing a water capsule and a coffee capsule into a coffee machine,
penetrating a back side of the coffee capsule via a first perforator configured to form a coffee hole in the back of the coffee capsule,
penetrating a water hole valve disposed on a back side of the water capsule via a tube disposed at an end of a sliding path so that water is released from the water capsule into a heater tank within the coffee machine,
heating the water via the heater tank,
injecting water from the heater tank into the coffee capsule through the coffee hole, and
forming coffee once the water mixes with the coffee in the coffee capsule.

12. The method according to claim 11, comprising the steps of:
penetrating the back side of the coffee capsule in three spots via the first perforator configured to form three symmetric coffee holes in the back of the coffee capsule, and
penetrating an aluminium covered water hole disposed on the back side of the water capsule via the metallic sharp tube disposed at the end of the sliding path.

13. The method according to claim 11, comprising the step of:
sliding down the water capsule the sliding path at the same time as the coffee capsule is being penetrated via the first perforator.

14. The method according to claim 11, comprising the step of:
flowing the water at a pressure of 20 bar through the coffee capsule and into a cup for producing the coffee.

15. The method according to claim 11, whereby the capsule comprises an air pressure hole disposed on the water capsule and configured to release air pressure once the coffee capsule is perforated during entrance of the water capsule into the coffee machine.

16. The capsule according to claim 2, whereby the guides are embossed on the water capsule.

17. The capsule according to claim 1, whereby the water capsule comprises a rectangular shape.

18. The capsule according to claim 1, whereby the coffee capsule comprises between 5 to 20 grams.

19. The capsule according to claim 1, whereby the coffee capsule comprises 7 to 12 grams of coffee in powder form.

20. The method according to claim 11, comprising the steps of:
injecting water from the heater tank into the coffee capsule through the coffee hole into a silicon tube, and
filling of a cup with the coffee from the silicon tube for between 10 to 20 seconds.
